(19) United States
(12) Patent Application Publication
(10) Pub. No.: US 2020/0058927 A1
(43) Pub. Date: Feb. 20, 2020

(54) Protected Anodes and Methods for Making and Using Same

(71) Applicant: The Board of Trustees of the University of Illinois, Jrbana, IL (US)

(72) Inventors: Amin Salehi-Khojin, Chicago, IL (US); Mohammad Asadi, Chicago, IL (US); Bahark Sayahpour, Chicago, IL (US); Pedram Abbasi, Chicago, IL (US); Marc Gerard, Dusseldorf (DE)

(21) Appl. No.: 16/342,630

(22) PCT Filed: Oct. 17, 2017
(86) PCT No.: PCT/US17/57008

§ 371 Date: Apr. 17, 2019

Related U.S. Application Data
(60) Provisional application No. 62/409,261, filed on Oct. 17, 2016.

(51) Int. Cl. H01M 4/134; H01M 4/62; H01M 4/36; H01M 4/38; H01M 10/44; H01M 12/08; H01M 10/052

(52) U.S. Cl. CPC H01M 4/134; H01M 4/628; H01M 4/366; H01M 2004/027; H01M 10/446; H01M 12/08; H01M 10/052; H01M 4/382

(57) ABSTRACT

The disclosure relates more specifically to protected anodes for batteries, and to methods for making such anodes. One aspect of the disclosure is a method for preparing a protected anode, the method including providing an electrochemical cell comprising a cathode comprising at least one transition metal dichalcogenide, an anode comprising a metal, an electrolyte in contact with the transition metal dichalcogenide of the cathode and the metal of the anode, and carbon dioxide dissolved in the electrolyte; and performing a discharge-charge cycle comprising discharging the electrochemical cell, and applying a voltage across the anode and the cathode for a time sufficient to charge the electrochemical cell; wherein the electrochemical cell is substantially free of water; and wherein one or more chemical species formed in the discharge-charge cycle and dissolved in the electrolyte are deposited onto the anode.

### CROSS-REFERENCE TO RELATED APPLICATIONS

This application claims the benefit of priority of U.S. Provisional Patent Application No. 62/409,261, filed Oct. 17, 2016, which is hereby incorporated herein by reference in its entirety.

### BACKGROUND OF THE DISCLOSURE

### Field of the Disclosure

The disclosure relates generally to batteries. The disclosure relates more specifically to protected anodes for batteries, and to methods for making such anodes.

### Description of Related Art

Rechargeable metal-sulfur, metal-air and metal-ion batteries have shown a tremendous potential to be the main source of power for many applications such as electric vehicles and microelectronics due to their remarkable energy density. However, the practical performance of these systems is limited due to their short cycle life affected by degradation of the anode electrode.

Specifically, the combination of a metal, e.g., lithium, anode and a liquid electrolyte solution is problematic for rechargeable batteries because of the high reactivity of the active metal with any relevant polar aprotic solvent and/or salt anion in electrolyte solutions. For example, the surface reaction of lithium metal with electrolyte components can result in the formation of a mosaic structure of insoluble surface species at the solid electrolyte interphase (SEI), causing a loss of anode materials and leading to low cycling efficiency, gradual capacity loss, and poor cyclability. Moreover, a complex, uneven SEI results in non-uniform current distribution of a lithium electrode, which can induce an internal short circuit in, e.g., a lithium ion battery.

Accordingly, there remains a need for a more robust, protected anode electrode with a longer cycle life in metal-sulfur, metal-air, and metal-ion batteries.

### SUMMARY OF THE DISCLOSURE

One aspect of the disclosure is a method for preparing a protected anode, the method including
providing an electrochemical cell comprising
   a cathode comprising at least one transition metal dichalcogenide,
   an anode comprising a metal,
   an electrolyte in contact with the transition metal dichalcogenide of the cathode and the metal of the anode, and
   carbon dioxide dissolved in the electrolyte; and
performing a discharge-charge cycle comprising
   discharging the electrochemical cell, and
   applying a voltage across the anode and the cathode for a time sufficient to charge the electrochemical cell;
wherein the electrochemical cell is substantially free of water; and
wherein one or more chemical species formed in the discharge-charge cycle and dissolved in the electrolyte are deposited onto the anode.

Another aspect of the disclosure is a method as described above, further including
removing the protected anode from the electrochemical cell after one or more discharge-charge cycles; and
configuring a battery comprising
   the protected anode,
   a cathode, and
   an electrolyte in contact with the anode, and optionally with the metal of the anode.

Another aspect of the disclosure is protected anode comprising a protective layer disposed on an anode comprising lithium metal, wherein the protective layer comprises Li₂CO₃ in an amount of at least 50 atom % of the protective layer.

Another aspect of the disclosure is a battery including a protected anode as described above, further comprising a cathode and an electrolyte in contact with the anode.

### BRIEF DESCRIPTION OF THE DRAWINGS

FIG. 1 is a graph of the performance of a lithium-air battery utilizing a protected anode prepared according to Example 1 over 800 charge-discharge cycles, as described in more detail in Example 2, below.

FIG. 2 is a graph showing the performance of an electrochemical cell utilizing protected anodes, prepared according to Example 1 as the working and counter electrodes, throughout the high rate cycling experiment, as described in more detail in Example 3, below.

FIG. 3 is a graph of the potential of the cell of Example 3 over the course of a low rate deep cycling experiment, performed after the high rate cycling experiment.

FIG. 4 is a representative XPS spectrum of the surface of a protected anode prepared according to Example 1, highlighting the Li 1s region. The experiment is described in more detail in Example 4, below.

FIG. 5 is a representative XPS spectrum of the surface of a protected anode prepared according to Example 1, highlighting the C 1s region. The experiment is described in more detail in Example 4, below.

FIG. 6 is a representative XPS spectrum of the surface of a protected anode prepared according to Example 1, highlighting the O 1s region. The experiment is described in more detail in Example 4, below.

FIG. 7 is a graph of the cycle life and first cycle polarization gap of lithium-air batteries utilizing a protected anode, as a function of the number of anode protection cycles performed, as described in more detail in Example 5, below.

FIG. 8 is an electrochemical impedance spectroscopy (EIS) spectrum of lithium-air batteries utilizing protected anodes prepared with a varied number of anode protection cycles, as described in more detail in Example 6, below.

FIG. 9 is a scanning electron microscopy (SEM) image of the surface of a protected anode prepared according to Example 1, as described in more detail in Example 7, below. The scale bar is 1 μm, and the inset image width is 500 nm.

FIG. 10 is a schematic of the lithium-air battery of Example 2.

### DETAILED DESCRIPTION OF THE DISCLOSURE

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice. Thus, before the disclosed processes and devices are described, it is to be understood that the aspects described herein are not limited to specific embodiments, apparati, or configurations, and as such can, of course, vary. It is also to be understood that the terminology used herein is for the purpose of describing particular aspects only and, unless specifically defined herein, is not intended to be limiting.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

All methods described herein can be performed in any suitable order of steps unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

As will be understood by one of ordinary skill in the art, each embodiment disclosed herein can comprise, consist essentially of or consist of its particular stated element, step, ingredient or component. As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% (lithe stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Some embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

In various aspects and embodiments, the disclosure relates to protected anodes prepared by discharging and charging an electrochemical cell comprising a cathode comprising at least one transition metal dichalcogenide, an anode comprising a metal, an electrolyte, and carbon dioxide, dissolved in the electrolyte. The disclosure demonstrates such protected anodes to have no adverse impact on battery performance while possessing a significantly increased cycle life.

One aspect of the disclosure is a method of preparing a protected anode. The method includes providing an electrochemical cell comprising a cathode comprising at least one transition metal dichalcogenide, an anode comprising a metal, an electrolyte in contact with the transition metal dichalcogenide of the cathode and the metal of the anode, and carbon dioxide dissolved in the electrolyte. The method includes performing a discharge-charge cycle comprising discharging the electrochemical cell, and applying a voltage across the anode and the cathode for a time sufficient to charge the electrochemical cell. One or more chemical species formed in the discharge-charge cycle and dissolved in the electrolyte are deposited on the anode. The electrochemical cell of the method is substantially free of water.

In certain embodiments, the electrochemical cell comprises water in an amount of less than 5 wt. % of the electrolyte, e.g., less than 4.5 wt. %, or less than 4 wt. %, or less than 3.5 wt. %, or less than 3 wt. %, or less than 2.5 wt. %, or less than 2 wt. %, or less than 1.5 wt. %, or less than 1 wt. %, or less than 0.75 wt. %, or less than 0.5 wt. % of the electrolyte.

In certain embodiments of the methods as otherwise described herein, the electrochemical cell is substantially free of H₂ and O₂. In certain embodiments, the electrochemical cell comprises H2 in an amount of less than about 5 wt. % of the electrolyte, e.g., less than about 4 wt. %, or less than about 3 wt. %, or less than about 2 wt. %, or less than about 1 wt. % of the electrolyte. In certain embodiments, the electrochemical cell comprises 02 in an amount of less than about 5 wt. % of the electrolyte, e.g., less than about 4 wt. %, or less than about 3 wt. %, or less than about 2 wt. %, or less than about 1 wt. % of the electrolyte. In certain embodiments, the electrochemical cell comprises O₂ and H₂ in a combined about of less than about 10 wt. % of the electrolyte, e.g., less than about 9 wt. %, or less than about 8 wt. %, or less than about 7 wt. %, or less than about 6 wt. %, or less than about 5 wt. %, or less than about wt. %, or less than about 3 wt. %, or less than about 2 wt. %, or less than about 1 wt. % of the electrolyte.

In certain embodiments of the methods as otherwise described herein, the method further comprises one or more additional discharge-charge cycles. In certain embodiments, the total number of discharge-charge cycles is from 2 to 25, e.g., from 2 to 24, or from 2 to 23, or from 2 to 22, or from 2 to 21, or from 2 to 21, or from 2 to 20, or from 2 to 19, or from 2 to 19, or from 2 to 18, or from 2 to 17, or from 2 to 16, or from 2 to 16, or from 2 to 15, or from 2 to 14, or from 2 to 13, or from 2 to 12, or from 2 to 11, or from 2 to 10, of from 2 to 9, or from 2 to 8, or from 2 to 7, or from 2 to 6, or from 2 to 5, or from 3 to 25, or from 4 to 25, or from 5 to 25, or from 6 to 25, or from 7 to 25, or from 8 to 25, or from 9 to 25, or from 10 to 25, or from 11 to 25, or from 12 to 25, or from 13 to 25, or from 14 to 25, or from 15 to 25, or from 16 to 25, or from 17 to 25, or from 18 to 25, or from 19 to 25, or from 20 to 25, or from 3 to 24, or from 4 to 23, or from 5 to 22, or from 5 to 21, or from 5 to 20, or from 5 to 19, or from 5 to 18, or from 5 to 17, or from 5 to 16, or from 5 to 15, or from 6 to 14, or from 7 to 13, or from 8 to 12, or from 9 to 11.

In certain embodiments of the methods as otherwise described herein, the voltage applied is within the range of about 1 V to about 5 V, e.g., about 1.25 V to about 4.75 V, or about 1.5 V to about 4.5 V, or about 1.75 V to about 4.25 V, or about 2 V to about 4 V, or about 2.25 V to about 3.75 V, or about 2.5 V to about 3.5 V, or the voltage is about 1.5 V, or about 1.75 V, or about 2 V, or about 2.25 V, or about 2.5 V, or about 2.75 V, or about 3 V, or about 3.25 V, or about 3.5 V, or about 3.75 V, or about 4 V, or about 4.25 V, or about 4.5 V.

As described above, in the methods and devices of the disclosure, the anode includes a metal. As the person of ordinary skill will appreciate, a variety of constructions are available for the anode. The anode can, for example, consist essentially of the metal (e.g., as a bar, plate, or other shape). In other embodiments, the anode can be formed from an alloy of the metal, or can be formed as a deposit of the metal on a substrate (e.g., a substrate formed from a different metal, or from another conductive material). As the person of ordinary skill in the art will appreciate, other materials that include the metal in its zero-valence state can be used. For example, in certain embodiments, the metal can be provided as part of a compound metal oxide or carbonaceous material from which the metal can be reduced to provide metal ion and one or more electrons.

As described above, in the methods and devices of the disclosure, the anode includes a metal and may be shaped as, for example, a bar, plate, chip, disc, etc. The person of ordinary skill in the art will appreciate that the anode may have a variety of different dimensions, for example, a chip with a thickness of 0.15 mm, 0.25 mm, 0.5 mm, 0.65 mm, etc.

Although lithium is often used as the metal of the anode, other embodiments of the disclosure are directed to other anode metals described herein. Accordingly, it should be understood that the descriptions herein with reference to lithium are by way of example only, and in other embodiments of the disclosure, other metals are used instead of and/or in addition to lithium, including those described herein. Metals suitable for use in the anode of the disclosure include, but are not limited to alkaline metals such as lithium, sodium and potassium, alkaline-earth metals such as magnesium and calcium, group 13 elements such as aluminum, transition metals such as zinc, iron and silver, and alloy materials that contain any of these metals or materials that contain any of these metals. In particular embodiments, the metal is selected from one or more of lithium, magnesium, zinc, and aluminum. In other particular embodiments, the metal is lithium.

When lithium is used as the metal of the anode, a lithium-containing carbonaceous material, an alloy that contains a lithium element, or a compound oxide, nitride or sulfide of lithium may be used. Examples of the alloy that contains a lithium element include, but are not limited to, lithium-aluminum alloys, lithium-tin alloys, lithium-lead alloys, and lithium-silicon alloys. Examples of lithium-containing compound metal oxides include lithium titanium oxide. Examples of lithium-containing compound metal nitrides include lithium cobalt nitride, lithium iron nitride and lithium manganese nitride.

As described above, in the methods and devices of the disclosure, the cathode includes at least one transition metal dichalcogenide. Examples of transition metal dichalcogenides include those selected from the group consisting of TiX₂, VX₂, CrX₂, ZrX₂, NbX₂, MoX₂, HfX₂, WX₂, TaX₂, TcX₂, and ReX₂, wherein X is independently S, Se, or Te. In one embodiment, each transition metal dichalcogenide is selected from the group consisting of TiX₂, MoX₂, and WX₂, wherein X is independently S, Se, or Te. In another embodiment, each transition metal dichalcogenide is selected from the group consisting of TiS₂. TiSe₂, MoS₂, MoSe₂, WS₂ and WSe₂. For example, in one embodiment, each transition metal dichalcogenide is TiS₂, MoS₂, or WS₂. In another embodiment, each transition metal dichalcogenide is MoS₂ or MoSe₂. The transition metal dichalcogenide may be MoS₂ in one embodiment.

The at least one transition metal dichalcogenide itself can be provided in a variety of forms, for example, as a bulk material, in nanostructure form, as a collection of particles, and/or as a collection of supported particles. As the person of ordinary skill in the art will appreciate, the transition metal dichalcogenide in bulk form may have a layered structure as is typical for such compounds. The transition metal dichalcogenide may have a nanostructure morphology, including but not limited to monolayers, nanotubes, nanoparticles, nanoflakes (e.g., multilayer nanoflakes), nanosheets, nanoribbons, nanoporous solids etc. As used herein, the term “nanostructure” refers to a material with a dimension (e.g., of a pore, a thickness, a diameter, as appropriate for the structure) in the nanometer range (i.e., greater than 1 nm and less than 1 μm). In some embodiments, the transition metal dichalcogenide is layer-stacked bulk transition metal dichalcogenide with metal atom-terminated edges (e.g., MoS₂ with molybdenum-terminated edges). In other embodiments, transition metal dichalcogenide nanoparticles (e.g., MoS₂ nanoparticles) may be used in the devices and methods of the disclosure. In other embodiments, transition metal dichalcogenide nanoflakes (e.g., nanoflakes of MoS₂) may be used in the devices and methods of the disclosure. Nanoflakes can be made, for example, via liquid exfoliation, as described in Coleman, J. N. et al. Two-dimensional nanosheets produced by liquid exfoliation of layered materials. Science 331, 568-71 (2011) and Yasaei, P. et al. High-Quality Black Phosphorus Atomic Layers by Liquid-Phase Exfoliation. Adv. Mater. (2015) (doi:10.1002/adma.201405150), each of which is hereby incorporated herein by reference in its entirety. In other embodiments, transition metal dichalcogenide nanoribbons (e.g., nanoribbons of MoS₂) may be used in the devices and methods of the disclosure. In other embodiments, TMDC nanosheets (e.g., nanosheets of MoS₂) may be used in the devices and methods of the disclosure. The person of ordinary skill in the art can select the appropriate morphology for a particular device.

In certain embodiments of the methods as otherwise described herein, the transition metal dichalcogenide nanostructures (e.g., nanoflakes, nanoparticles, nanoribbons, etc.) have an average size between about 1 nm and 1000 nm. The relevant size for a nanoparticle is its largest diameter. The relevant size for a nanoflake is its largest width along its major surface. The relevant size for a nanoribbon is its width across the ribbon. The relevant size for a nanosheet is its thickness. In some embodiments, the transition metal dichalcogenide nanostructures have an average size between from about 1 urn to about 400 nm, or about 1 nm to about 350 nm, or about 1 nm to about 300 nm, or about 1 nm to about 250 nm, or about 1 nm to about 200 nm, or about 1 nm to about 150 nm, or about 1 nm to about 100 nm, or about 1 nm to about 80 nm, or about 1 nm to about 70 nm, or about 1 nm to about 50 nm, or 50 nm to about 400 nm, or about 50 nm to about 350 nm, or about 50 nm to about 300 nm, or about 50 nm to about 250 nm, or about 50 nm to about 200 nm, or about 50 nm to about 150 nm, or about 50 nm to about 100 nm, or about 10 nm to about 70 nm, or about 10 nm to about 80 nm, or about 10 nm to about 100 nm, or about 100 nm to about 500 nm, or about 100 nm to about 600 nm, or about 100 nm to about 700 nm, or about 100 nm to about 800 nm, or about 100 nm to about 900 nm, or about 100 nm to about 1000 nm, or about 400 nm to about 500 nm, or about 400 nm to about 600 nm, or about 400 nm to about 700 nm, or about 400 nm to about 800 nm, or about 400 nm to about 900 nm, or about 400 nm to about 1000 nm. In certain embodiments, the transition metal dichalcogenide nanostructures have an average size between from about 1 nm to about 200 nm. In certain other embodiments, the transition metal dichalcogenide nanostructures have an average size between from about 1 nm to about 400 nm. In certain other embodiments, the transition metal dichalcogenide nanostructures have an average size between from about 400 nm to about 1000 nm. In certain embodiments, the transition metal dichalcogenide nanostructures are nanoflakes having an average size between from about 1 nm to about 200 nm. In certain other embodiments, the transition metal dichalcogenide nanoflakes have an average size between from about 1 nm to about 400 nm. In certain other embodiments, the transition metal dichalcogenide nanoflakes have an average size between from about 400 nm to about 1000 nm.

In certain embodiments of the methods as otherwise described herein, transition metal dichalcogenide nanoflakes have an average thickness between about 1 nm and about 100 μm (e.g., about 1 nm to about 10 μm, or about 1 nm to about 1 μm, or about 1 nm to about 1000 nm, or about 1 nm to about 400 nm, or about 1 nm to about 350 nm, or about 1 nm to about 300 nm, or about 1 nm to about 250 nm, or about 1 nm to about 200 nm, or about 1 nm to about 150 nm, or about 1 nm to about 100 nm, or about 1 nm to about 80 nm, or about 1 nm to about 70 nm, or about 1 nm to about 50 nm, or abou6t 50 nm to about 400 nm, or about 50 nm to about 350 nm, or about 50 nm to about 300 nm, or about 50 nm to about 250 nm, or about 50 nm to about 200 nm, or about 50 nm to about 150 nm, or about 50 nm to about 100 nm, or about 10 nm to about 70 nm, or about 10 nm to about 80 nm, or about 10 nm to about 100 nm, or about 100 nm to about 500 nm, or about 100 nm to about 600 nm, or about 100 nm to about 700 nm, or about 100 nm to about 800 nm, or about 100 nm to about 900 nm, or about 100 nm to about 1000 nm, or about 400 nm to about 500 nm, or about 400 nm to about 600 nm, or about 400 nm to about 700 nm, or about 400 nm to about 800 nm, or about 400 nm to about 900 nm, or about 400 nm to about 1000 nm); and an average dimensions along the major surface of about 20 nm to about 100 μm (e.g., about 20 nm to about 50 μm, or about 20 nm to about 10 μm, or about 20 nm to about 1 μm, or about 50 nm to about 100 μm, or about 50 nm to about 50 μm, or about 50 nm to about 10 μm, or about 50 nm to about 1 μm, or about 100 nm to about 100 μm, or about 100 nm to about 50 μm, or about 100 nm to about 10 μm, or about 100 nm to about 1 μm). The aspect ratio (largest major dimension:thickness) of the nanoflakes can be on average, for example, at least about 5:1, at least about 10:1 or at least about 20:1. For example, in certain embodiments the transition metal dichalcogenide nanoflakes have an average thickness in the range of about 1 nm to about 1000 nm (e.g., about 1 nm to about 100 nm), average dimensions along the major surface of about 50 nm to about 10 μm, and an aspect ratio of at least about 5:1.

One of skill in the art will recognize that the at least one transition metal dichalcogenide of the cathode may be provided in a variety of forms, provided that it is in contact with the electrolyte. For example, the transition metal dichalcogenide can be disposed on a substrate. For example, the transition metal dichalcogenide can be disposed on a porous member, which can allow gas (e.g., CO₂) to diffuse through the member to the TMDC. The porous member may be electrically-conductive. In cases where the porous member is not electrically conductive, the person of skill in the art can arrange for the electrical connection of the cathode to be made to some other part of the cathode. The substrate may be selected to allow CO₂ to be absorbed in a substantial quantity into the device and transmitted to the TMDC. Examples of the porous materials for the substrate include carbon-based materials, such as carbon as well as carbon blacks (e.g., Ketjen black, acetylene black, channel black, furnace black, and mesoporous carbon), activated carbon and carbon fibers. In one embodiment, a carbon material with a large specific surface area is used. A material with a pore volume on the order of 1 mL/g can be used. In another case, a cathode can be prepared by mixing TMDC with conductive material (e.g. SUPER P brand carbon black) and binder (e.g., PTFE) followed by coating on a current collector (e.g., aluminum mesh). The ratio of these elements can generally vary. In various embodiments, the TMDC-containing cathode material (e.g., material that is coated onto a current collector) includes at least 10 wt %, at least 20 wt %, at least 50 wt %, at least 70 wt %, 10-99 wt %, 20-99 wt %, 50-99 wt %, 10-95 wt %, 20-95 wt %, 50-95 wt %, 10-70 wt %, 20-70 wt %, 40-70 wt % or 70-99 wt % TMDC. In certain embodiments, it can be 95 wt % TMDC, 4 wt % PTFE binder and 5 wt % super P; or 50 wt % TMDC, 40 wt % PTFE binder and 10 wt % super P.

The TMDC-containing material can be coated onto a current collector or a porous member at any convenient thickness, e.g., in thicknesses up to 1000 μm. The overall cathode desirably has some porosity so that CO₂ can be provided to the TMDC material.

One of skill in the art would be able to optimize the amount of the TMDC present in the gas diffusion material present at the cathode.

As described above, in the devices and methods of the disclosure the electrolyte comprises at least 1% of an ionic liquid. One of skill in the art will also recognize that the term “ionic liquid” refers to an ionic substance (i.e., a combination of a cation and an anion) that is liquid at standard temperature and pressure (25° C., 1 atm). In certain embodiments, the ionic liquid is a compound comprising at least one positively charged nitrogen, sulfur, or phosphorus group (for example, a phosphonium or a quaternary amine). In certain embodiments, the electrolyte comprises at least 10%, at least 20%, at least 50%, at least 70%, at least 85%, at least 90% or even at least 95% ionic liquid.

Specific examples of ionic liquids include, but are not limited to, one or more of salts of: acetylcholines, alanines, arninoacetonitriles, methylarnmoniums, arginines, aspartic acids, threonines, chloroformarnidiniums, thiouroniurns, quinoliniums, pyrrolidinols, serinols, benzamidines, sulfamates, acetates, carbamates, inflates, and cyanides. The person of ordinary skill in the art will select such salts that are in liquid form at standard temperature and pressure. These examples are meant for illustrative purposes only, and are not meant to limit the scope of the present disclosure.

In some embodiments, the ionic liquid of the disclosure may be an imidazolium salt, such as 1-ethyl-3-methylimidazolium tetrafluoroborate, 1-ethyl-3-methylimidazolium bis(trifluoromethanesulfonyl)imide, 1-ethyl-3-methylimidazolium trifluoromethanesulfonate, 1-butyl-3-methylimidazolium tetrafluoroborate, 1-butyl-3-methylimidazolium bis(trifluoromethanesulfonyl)imide, or 1-butyl-3-methylimidazolium trifluoromethanesulfonate; a pyrrolidinium salt, such as 1-butyl-1-methylpyrrolidinium tetrafluoroborate, 1-butyl-1-methylpyrrolidinium bis(trifluoromethanesulfonyl)imide, or 1-butyl-1-methylpyrrolidinium trifluoromethanesulfonate; a piperidinium salt, such as 1-butyl-1-methylpiperidinium tetrafluoroborate, 1-butyl-1-methylpiperidinium bis(trifluoromethanesulfonyl)imide, or 1-butyl-1-methylpiperidinium trifluoromethanesulfonate; an ammonium salt, such as amyltriethylammonium bis(trifluoromethanesulfonyl)imide, or methyltri-n-octylammonium bis(trifluoromethanesulfonyl)imide; or a pyridinium salt, such as 1-ethyl-3-methylpyridinium bis(trifluoromethanesulfonyl)imide.

In certain embodiments, the ionic liquids of the disclosure include, but are not limited to imidazoliums, pyridiniums, pyrrolidiniums, phosphoniums, ammoniums, sulfoniums, prolinates, and methioninates salts. The anions suitable to form salts with the cations include, but are not limited to C₁-C₆ alkylsulfate, tosylate, methanesulfonate, bis(trifluoromethylsulfonyl)imide, hexafluorophosphate, tetrafluoroborate, triflate, halide, carbamate, and sulfamate. In particular embodiments, the ionic liquid may be a salt of the cations selected from those illustrated below:

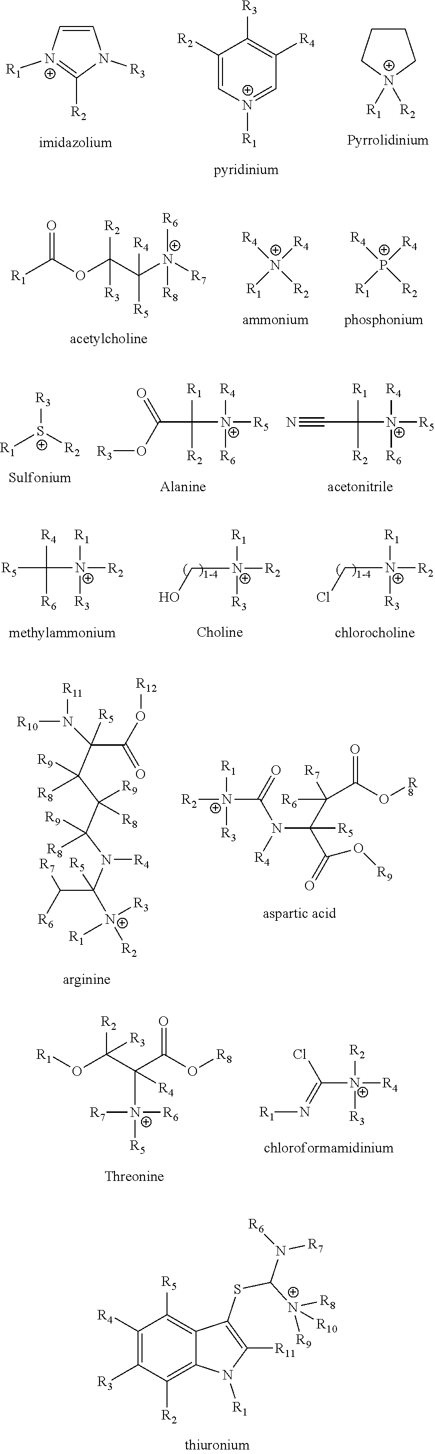

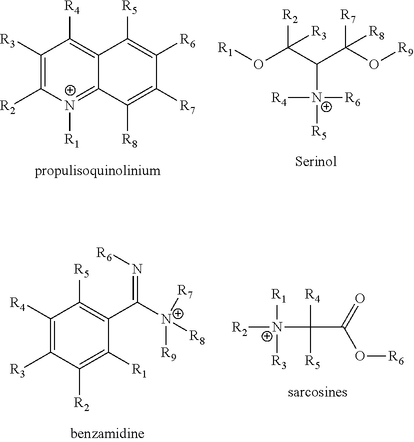

wherein R₁-R₁₂ are independently selected from the group consisting of hydrogen, —OH, linear aliphatic C₁-C₆ group, branched aliphatic C₁-C₆ group, cyclic aliphatic C₁-C₆ group, —CH₂OH, —CH₂CH₂OH, —CH₂CH₂CH₂OH, —CH₂CHOHCH₃, —CH₂COH, —CH₂CH₂COH, and —CH₂COCH₃.

In certain embodiments, the ionic liquid of the methods and devices of the disclosure is imidazolium salt of formula:

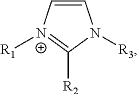

wherein R₁, R₂, and R₃ are independently selected from the group consisting of hydrogen, linear aliphatic C₁-C₆ group, branched aliphatic C₁-C₆ group, and cyclic aliphatic C₁-C₆ group. In other embodiments, R₂ is hydrogen, and R₁ and R₃ are independently selected from linear or branched C₁-C₄ alkyl. In particular embodiments, the ionic liquid of the disclosure is an 1-ethyl-3-methylimidazolium salt. In other embodiments, the ionic liquid of the disclosure is 1-ethyl-3-methylimidazolium tetrafluoroborate (EMIM-BF₄).

In general, a person of skill in the art can determine whether a given ionic liquid is a co-catalyst for a reaction (R) catalyzed by TMDC as follows:
(a) fill a standard 3 electrode electrochemical cell with the electrolyte commonly used for reaction R. Common electrolytes include such as 0.1 M sulfuric acid or 0.1 M KOH in water can also be used;
(b) mount the TMDC into the 3 electrode electrochemical cell and an appropriate counter electrode;
(c) run several CV cycles to clean the cell;
(d) measure the reversible hydrogen electrode (RHE) potential in the electrolyte;
(e) load the reactants for the reaction R into the cell, and measure a CV of the reaction R, noting the potential of the peak associated with the reaction R;
(f) calculate VI, which is the difference between the onset potential of the peak associated with reaction and RHE;
(g) calculate VIA, which is the difference between the maximum potential of the peak associated with reaction and RHE;
(h) add 0.0001 to 99.9999 weight % of the ionic liquid to the electrolyte;
(i) measure RHE in the reaction with ionic liquid;
(j) measure the CV of reaction R again, noting the potential of the peak associated with the reaction R;
(k) calculate V2, which is the difference between the onset potential of the peak associated with reaction and RHE; and
(l) calculate V2A, which is the difference between the maximum potential of the peak associated with reaction and RHE.
   If V2<V1 or V2A<VIA at any concentration of the ionic liquid (e.g., between 0.0001 and 99.9999 weight %), the ionic liquid is a co-catalyst for the reaction.

In some embodiments, the ionic liquid is present in the electrolyte within the range from about 50 weight % to about 100 weight %, or about 50 weight % to about 99 weight %, or about 50 weight % to about 98 weight %, or about 50 weight % to about 95 weight %, or about 50 weight % to about 90 weight %, or about 50 weight % to about 80 weight %, or about 50 weight % to about 70 weight %, or about 50 weight % to about 60 weight %, or about 80 weight % to about 99 weight %, from about 80 weight % to about 98 weight %, or about 80 weight % to about 95 weight %, or about 80 weight % to about 90 weight %, or about 70 weight % to about 99 weight %, from about 70 weight % to about 98 weight %, or about 70 weight % to about 95 weight %, or about 70 weight % to about 90 weight %, or about 70 weight % to about 80 weight %, or about 50 weight %, or about 70 weight %, or about 80 weight %, or about 90 weight %, or about 95 weight %, or about 96 weight %, or about 97 weight %, or about 98 weight %, or about 99 weight of the aqueous solution. In certain embodiments, the ionic liquid is present in the electrolyte within the range from about 75 weight % to about 100 weight %, or about 90 weight % to about 100 weight %. In some other embodiments, the ionic liquid is present in an electrolyte at about 90 weight %. In other embodiments, the electrolyte consists essentially of the ionic liquid.

In certain embodiments, the electrolyte may further include a solvent, a buffer solution, an additive to a component of the system, or a solution that is bound to at least one of the catalysts in a system. In certain embodiments, the electrolyte may include an aprotic organic solvent. Some suitable solvents include, but are not limited to dioxolane, dimethylsulfoxide (DMSO), diethylether, tetraethyleneglycol dimethylether (TEGDME), dimethyl carbonate (DMC), diethylcarbonate (DEC), dipropylcarbonate (DPC), ethylmethylcarbonate (EMC), ethylene carbonate (EC), propylene carbonate (PC), tetrahydrofuran (THF), butylene carbonate, lactones, esters, glymes, sulfoxides, sulfolanes, polyethylene oxide (PEO) and polyacrylnitrile (PAN), alone or in any combination. In certain embodiments, non-ionic liquid organic solvents are present in an amount of less than about 40 weight %, less than about 30 weight %, less than about 20 weight %, less than about 10 weight %, less than about 5 weight %, or even less than about 1 weight %. In certain embodiments, the electrolyte is substantially free non-ionic liquid organic solvents.

In certain embodiments, the electrolyte may further comprise other species, such as acids, bases, and salts. In certain embodiments, the electrolyte may include a metallic ion, e.g., lithium ion, magnesium ion, zinc ion, aluminum ion, etc. In one embodiment, the electrolyte may include lithium ion. In certain embodiments, the electrolyte may include a salt of the metal of the anode (e.g., when the anode includes metallic lithium, the electrolyte may include a lithium salt, such as lithium perchlorate, lithium bis(trifluoromethanesulfonyl)imide, lithium hexafluorophosphate, lithium triflate, Lithium hexafluoroarsenate, etc.). In certain embodiments, the salt of the metal of the anode is present in a concentration in the range of about 0.005 M to about 5 M, about 0.01 M to about 1 M, or about 0.02 M to about 0.5 M. The inclusion of such other species would be evident to the person of ordinary skill in the art depending on the desired electrochemical and physicochemical properties to the electrolyte, and are not meant to limit the scope of the present disclosure.

As described above, in the devices and methods of the disclosure the electrochemical cell comprises carbon dioxide, dissolved in the electrolyte. In certain embodiments, the carbon dioxide is present in the electrolyte in a concentration of at least about 5% of the saturated concentration of carbon dioxide in the electrolyte, e.g., at least about 7.5%, or at least about 10%, or at least about 12.5%, or at least about 15%, or at least about 17.5%, or at least about 20%, or at least about 22.5%, or at least about 25%, or at least about 30%, or at least about 35%, or at least about 40%, or at least about 45%, or at least about 50%, or at least about 55%, or at least about 60%, or at least about 65%, or at leat about 70%, or at least about 75%, or at least about 80%, or at least about 85%, or at least about 90%, or at least about 95%, or at least about 96%, or at least about 97%, or at least about 98%, or at least about 99% of the saturated concentration of carbon dioxide in the electrolyte.

In certain embodiments, the method further comprises removing the protected anode from the electrochemical cell after one or more discharge-charge cycles; and configuring a battery comprising the protected anode, a cathode, and an electrolyte in contact with the anode, and optionally with the metal of the anode.

Another aspect of the disclosure is a protected anode made by a method as otherwise described herein.

Another aspect of the disclosure is a protective anode comprising a protective layer disposed on an anode comprising lithium metal, wherein the protective layer comprises Li₂CO₃ in an amount of at least 50 atom % of the protective layer. In some embodiments, the protective layer has a thickness within the range of about 5 nm to about 5 μm, e.g., about 5 nm to about 40 μm, or about 5 nm to about 30 μm, or about 5 nm to about 20 μm, or about 5 nm to about 10 μm, or about 5 nm to about 9 μm, or about 5 nm to about 8 μm, or about 5 nm to about 7 μm, or about 5 nm to about 6 μm, or about 5 nm to about 5 μm, or about 5 nm to about 4 μm, or about 5 nm to about 3 μm, or about 5 nm to about 2 μm, or about 5 nm to about 1 μm, or about 5 nm to about 900 nm, or about 5 nm to about 800 nm, or about 5 nm to about 700 nm, or about 5 nm to about 600 nm, or about 5 nm to about 500 nm, or about 5 nm to about 450 nm, or about 5 nm to about 400 nm, or about 5 nm to about 350 nm, or about 5 nm to about 300 nm, or about 5 nm to about 250 nm, or about 5 nm to about 200 nm, or about 10 nm to about 5 μm, or about 15 nm to about 5 μm, or about 20 nm to about 5 μm, or about 25 nm to about 5 μm, or about 50 nm to about 5 μm, or about 75 nm to about 5 μm, or about 100 nm to about 5 μm, or about 150 nm to about 5 μm, or about 200 nm to about 5 μm, or about 250 nm to about 5 μm, or about 300 nm to about 5 μm, or about 350 nm to about 5 μm, or about 400 nm to about 5 μm, or about 450 nm to about 5 μm, or about 500 nm to about 5 μm, or about 600 nm to about 5 μm, or about 700 nm to about 5 μm, or about 800 nm to about 5 μm, or about 900 nm to about 5 μm, or about 1 μm to about 5 μm, or about 1.25 μm to about 5 μm, or about 1.5 μm to about 5 μm, or about 1.75 μm to about 5 μm, or about 2 μm to about 5 μm, or about 2.25 to about 5 μm, or about 2.5 μm to about 5 μm.

Another aspect of the disclosure is a battery comprising a protected anode described herein or made by a method as described herein, a cathode, and an electrolyte in contact with the anode, and optionally with the metal of the anode.

The person of ordinary skill in the art will appreciate that the battery may be any battery in which the protected anode made by a method as described herein is suitable, e.g., a metal-sulfur better, a metal-air battery, or a metal-ion battery. In certain embodiments, the battery is a metal-air battery. In certain embodiments, the battery is a metal-air battery wherein the cathode comprises at least one transition metal dichalcogenide. For example, in one embodiment, the battery is a metal-air battery described in WO2016/100204. In other embodiments, the cathode of the battery does not comprise a transition metal dichalcogenide. In certain embodiments, the battery is a metal-air battery wherein the electrolyte comprises at least 50 wt. % of an ionic liquid. In certain embodiments, the battery cell comprises water, H₂, and/or O₂ in an amount greater than the amount of water, H₂, and/or O₂ comprising the electrochemical cell of the method of producing a protected anode as otherwise described herein.

### EXAMPLES

The Examples that follow are illustrative of specific embodiments of the invention, and various uses thereof. They are set forth for explanatory purposes only, and are not to be taken as limiting the invention.

### Example 1

### Anode Protection

Protected anodes were prepared by including the anode to be protected in an electrochemical battery cell also comprising a MoS₂ nanoflake cathode and electrolyte.

Cathode Preparation

MoS₂ nanoflakes were synthesized using a liquid exfoliation method in which 300 mg MoS₂ powder (99%, Sigma-Aldrich) was dispersed in 60 mL isopropyl alcohol (IPA) (>99.5%, Sigma-Aldrich). The solution was then exfoliated for 30 hrs and centrifuged for 1 hr to extract the nanoflakes from the unexfoliated powder. Dynamic Light Scattering (DLS) analysis indicated a uniform size distribution of synthesized MoS₂ nanoflakes in the narrow range of 110-150 nm with an average flake size of 135 nm. MoS₂ nanoflakes (0.2 mg) were coated onto a conductive substrate of a gas diffusion layer (GDL) (0.2 mm thickness, 80% porosity, Fuel Cells Etc.) with a surface area of 1 cm⁻². Prepared cathodes were dried in a vacuum oven for 24 hrs at 85° C. to stabilize the cathode and remove impurities. This procedure resulted in identically prepared cathode samples with a consistent catalyst loading of 0.2 mg/cm⁻² on GDL substrates.

Anode Preparation

The anodes to be protected were prepared from pure lithium chips with a thickness of 0.25 mm (>99.9%, Sigma Aldrich).

Electrolyte Preparation

The electrolyte solution was prepared by dissolving 0.1 M Lithium Bis (Trifluoromethanesulfonyl) Imide (LiTFSI) (>99.0%, Sigma-Aldrich) into a mixture of 25% 1-Ethyl-3-methylimidazolium tetrafluoroborate (EMIM BF4) (HPLC, >99.0%, Sigma-Aldrich) and 75% dimethyl sulfoxide (DMSO) (Sigma-Aldrich).

Battery Cell Preparation

All battery systems were assembled with a custom made Swagelok battery set-up in Argon (Ar) filled glove-box. This setup comprised the cathode, the anode, and three droplets of the electrolyte. A glass microfiber filter was used as a separator to prevent direct contact between the cathode and the anode.

Anode Protection Procedure

The assembled battery cell was first purged with pure CO₂ (99.99%, Praxair Inc.) in order to remove gas impurities and prevent parasitic reactions. The CO₂-filled battery was then connected to a potentiostat (MTI Corporation) for cycling measurements. A 0.1 mA/cm⁻¹ constant current was applied for 10 continuous cycles, each cycle consisting of a one hour charge process followed by a one hour discharge process. In-situ measurements of voltage as a function of time and capacity were recorded,

### Example 2

### Performance of Lithium-Air Battery with a Protected Anode

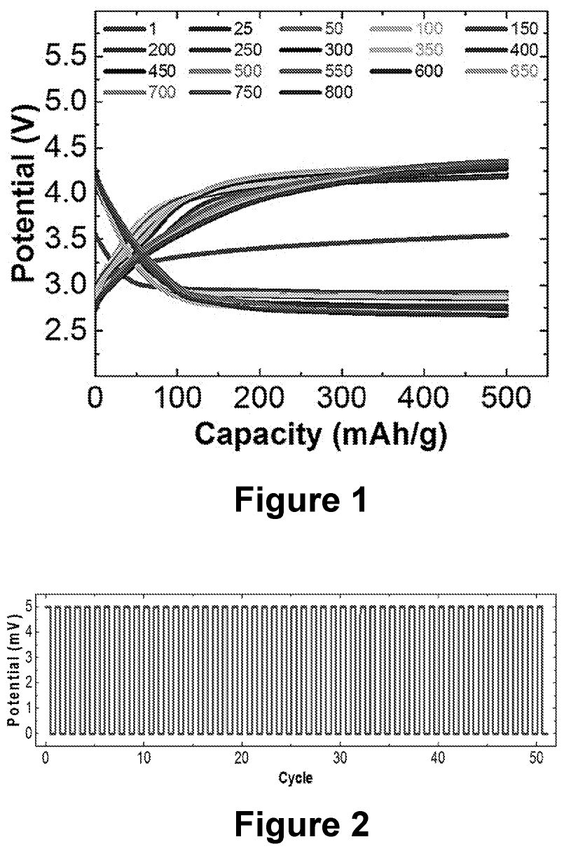

A protected anode prepared according to Example 1 was incorporated into a lithium air battery configured as shown in FIG. 10, wherein the protected anode and cathode were separated by a glass fiber filter wetted with electrolyte. The cathode and electrolyte were prepared according to Example 1. The assembled battery was first purged with an air mixture of ˜21% Oxygen (O₂), ˜79% Nitrogen (N₂), 500 ppm CO₂, and 45% relative humidity (RH) in order to remove gas impurities and prevent parasitic reactions. The air mixture was custom-made (Praxair Inc.) with an accuracy of ±1% for CO₂ and ±0.02% for O₂. Humidity was added to the gas flow before introduction to the battery. The RH and temperature of the air flow were tracked during purging by a sensor (Silicon Labs SI 700 x) to maintain the RH at 45% and the temperature at 25° C.±1° C. (room temperature). The RH and temperature versus time were recorded (Si700x Evaluation software) continuously. The lithium-air battery was connected to a potentiostat for cycling measurements. A 0.1 mA/cm⁻¹ constant current was applied for 800 cycles, each cycle consisting of a one hour charge process followed by a one hour discharge process. In-situ measurements of voltage as a function of the cycle number and capacity were recorded (See, FIG. 1). Through 800 cycles, there was negligible variation in battery performance. These results showed an increase in the number of cycles for which the polarization gap remains unchanged of more than an order of magnitude over a battery utilizing a bare lithium anode, without any adverse impact on overall battery performance.

### Example 3

### Columbic Efficiency of a Protected Anode

The columbic efficiency (CE) of a protected anode was tested by high rate cycling followed by exhaustive stripping of the anode. To prepare the cell, two lithium anodes with an initial theoretical capacity of Q₀=10.2 mAh/cm² were separately protected according to Example 1. The protected anodes were then incorporated, as working and counter electrodes, into a 2016 coin cell utilizing a glassy fiber separator and an electrolyte comprising 25%175% ionic liquid/DMSO with 0.1M LiTFSI.

High Rate Cycling

The cell was subjected to a specified number of cycles (N=51 cycles), each cycle consisting of a one hour charge process, wherein a current density of 2 mA/cm² was applied, followed by a one hour discharge process. This resulted in a cycling capacity of Q_{c}=2 mAh/cm². During discharge, 19.6 weight % of the lithium of the working electrode was transferred to the counter electrode. During charging, the same amount of lithium was transferred back to the working electrode. These results, shown in FIG. 2, wherein the amount of lithium transferred back and forth between the working and counter electrodes remains the same throughout the cycling experiment, is ideal because any accumulation of lithium at the counter electrode could decrease the coulombic efficiency of the system.

Low Rate Deep Cycling

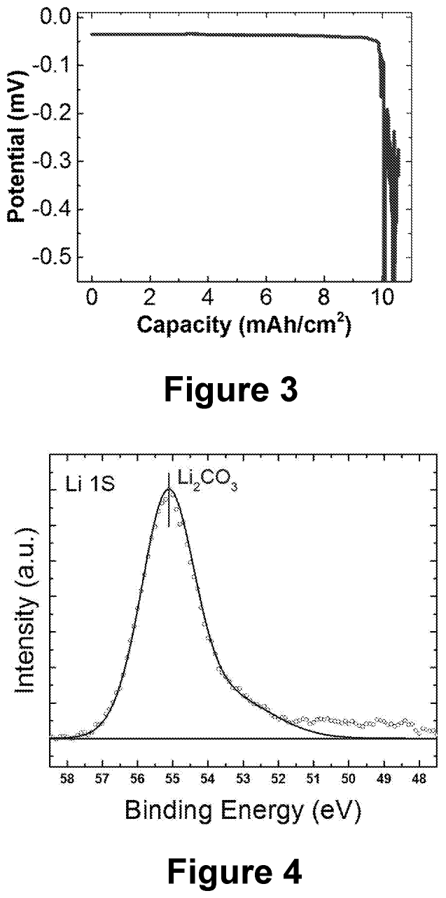

After the high rate cycling experiment, a low rate deep cycling experiment was performed on the working electrode. A current density of 0.5 mA/cm² was applied (4 times lower than that used in the cycling experiment, in order to minimize lithium dendrite growth and deformation of the solid electrolyte interface (SEI) (i.e., the interface between the lithium electrode and the electrolyte)). The current was continuously applied until the cell voltage reached −0.5 V (FIG. 3), at which point the lithium at the working electrode had been completely stripped. The capacity, at which the voltage reached −0.5 V, in this case 9.98 mAh/cm², is the maximum capacity of the working electrode.

Coulombic Efficiency Calculation

The columbic efficiency of the lithium anode then was calculated using the following equation:

$$CE = 1 - \frac{{Q}_{0} - {Q}_{f}}{{Q}_{c} N}$$

Wherein Q₀ is the theoretical lithium capacity of the electrode (10.2 mAh/cm²), Q_{f} is the maximum capacity of the working electrode after deep cycling experiment (9.98 mAh/cm²), Q_{c} is the capacity of the cell during high rate cycling (2 mA/cm²) and N is the number of high rate cycles performed (51 cycles).

The coulombic efficiency of the protected anode was therefore 98.9%.

### Example 4

### XPS of a Protected Anode Surface

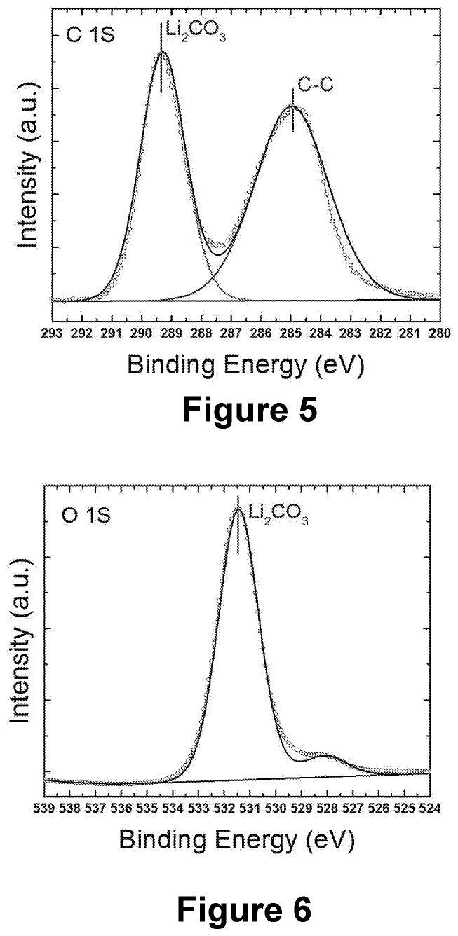

X-ray photoelectron spectroscopy (XPS) experiments were carried out using a Thermo Scientific ESCALAB 250Xi instrument. The instrument was equipped with an electron flood and scanning ion gun. To prevent samples from oxidation and contamination, protected anodes were carefully rinsed with dimethyl carbonate (DMC) and dried under an argon flow before characterization. A mobile glove box filled with Ar was used for transferring the samples into the loading chamber of the instrument. All spectra were calibrated to the C1s binding energy of 284.8 eV. To quantify the atomic concentration of each element, all data were processed by Thermo Avantage software, based on Scofield sensitivity factors. The background signal was removed by the Shirly method. The representative XPS spectra of the anode surface in the Li 1s, C 1s, and O 1s regions consistently showed that the protected layer on the anode surface was mainly Li₂CO₃. As indicated in the spectra (See, FIGS. 4-6), the reference binding energies for Li₂CO₃ in the Li 1s, C 1s, and O 1s regions are 55.15 eV, 289.5 eV, and 531.5 eV, respectively.

No evidence of other products such as Li₂O, Li₂O₂, or LiOH was observed. The standard binding energies for these products in the Li is region are 55.6 eV, 54.5 eV, 54.9 eV, respectively, and in the O 1s region are 531.3 eV, 531 eV, and 531 eV, respectively. These spectra show binding energies that are in good accordance with the standard binding energies of Li₂CO₃.

Elemental quantification results based on the surface area of the corresponding peak of each element further confirm the atomic ratio of Li₂CO₃ as the main product on the surface of the lithium anode:

TABLE 1
Atomic Percentage of Surface Elements

| Element | Atomic Percentage (%) |
|---|---|
| Li1s | 29.79 |
| C1s (Li2CO3) | 10.37 |
| C1s (C-C) | 13.48 |
| O1s | 46.36 |

The physical and electronic properties of Li₂CO₃ provide for both ionic conduction and electronic insulation properties, which are two essential properties for any protective interphase utilized in, for example, secondary lithium batteries. Without being bound by theory, the ionic conductivity of an Li₂CO₃ layer may allow for Li⁺ diffusion to or from an underlying anode, while the electronic insulativity prevents any poisoning of the anode.

### Example 5

### Thickness-Dependant Performance of Protective Layer

The effect of the number of cycles performed in the anode protection process was investigated. Protected anodes were prepared according to Example 1, but the number of charge-discharge cycles (i.e., anode protection cycles) was varied (5, 10, 15, and 20 cycles). After protection, anodes were incorporated into a lithium air battery prepared according to Example 2. The air-filled batteries were then connected to a potentiostat (MTI Corporation) for cycling measurements. The cell was subjected to a specified number of cycles, each cycle consisting of a one hour charge process, wherein a current density of 0.1 mA/cm² was applied, followed by a one hour discharge process. In-situ measurements of voltage as a function of time and capacity were recorded.

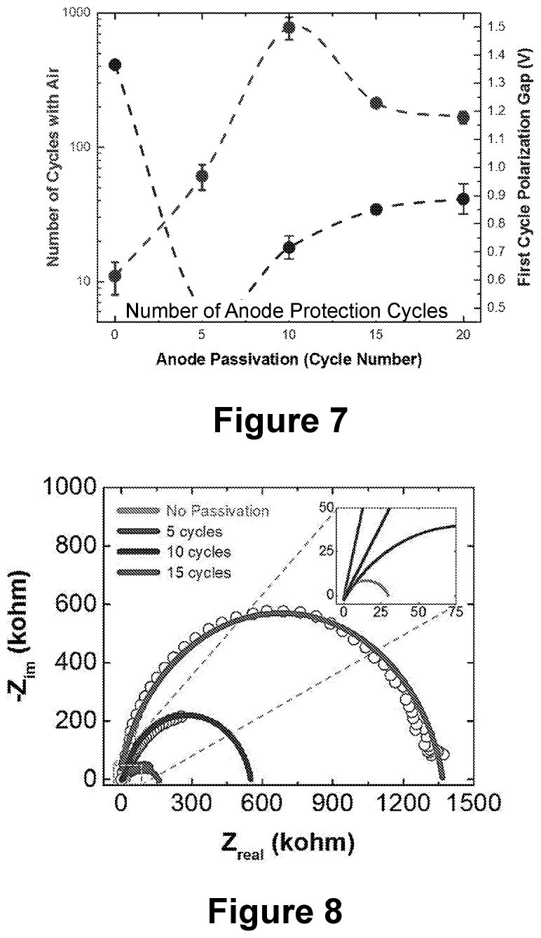

FIG. 7 shows the cycle life of the lithium air battery and the first cycle polarization gap as a function of the number of protection cycles (which is correlated to the thickness of the protective layer). The cycle life of the battery was shown to be around 60 cycles after 5 anode protection cycles, and 800 cycles after 10 anode protection cycles. The opposite trend was observed for the polarization gap of the Li-air battery as a function of the number of anode protection cycles, wherein the smallest polarization gap was observed at 5 anode protection cycles. The polarization gap for the first cycle without anode protection was 1.366 V. The potential gap dropped to 0.4933 V for the battery comprising an anode after 5 protection cycles. Beyond 5 protection cycles, the first cycle polarization gap increased as the number of anode protection cycles increased, up to 20 cycles.

These results suggest that the optimum number of anode protection steps is about 10 cycles for a Li-air battery.

### Example 6

### EIS Characterization of Lithium-Air Battery with a Protected Anode

To investigate the effect of the thickness of the anode protective layer on the stability and efficiency of the cell, protected anodes were prepared according to Example 1, but with a varying number of anode protection cycles (5, 10, and 15 cycles), and incorporated into lithium-air batteries prepared according to Example 2. For each electrochemical impedance spectroscopy (EIS) experiment, a fresh cathode with a known loading of catalyst and an identical electrolyte were used to avoid any contamination or external resistance in the system, in order to secure an independent study of the electrochemical properties of the protected anode. The battery cells were connected to a potentiostat (Volta Lab PGZ 100), and measurements were performed with a 700 mV overpotential at a frequency range of 10 Hz to 100 kHz.

FIG. 8 shows the EIS results with respect to the number of anode protection cycles. The charge transfer resistance (R_{ct}) of the anode after 10 protection cycles was about 550 kohms, while it was about 160 and 1350 kohms after 5 and 15 cycles, respectively. The charge transfer resistance for an unprotected anode was 30 kohms.

Without being bound by theory, the increase in cell resistance may be attributed to the presence of Li₂CO₃ on the anode surface. A thicker protective layer leads to more charge transfer resistance in the cell. The thickness of the protective layer after 5 anode protection cycles was not enough to protect the Li-Air battery for an extended amount time, while 15 anode protection cycles makes the resistance in the cell too high to be considered suitable for such a battery.

Based on these results, the anode after 10 protection cycles showed the best electrochemical performance.

### Example 7

### SEM Characterization of a Protected Anode Surface

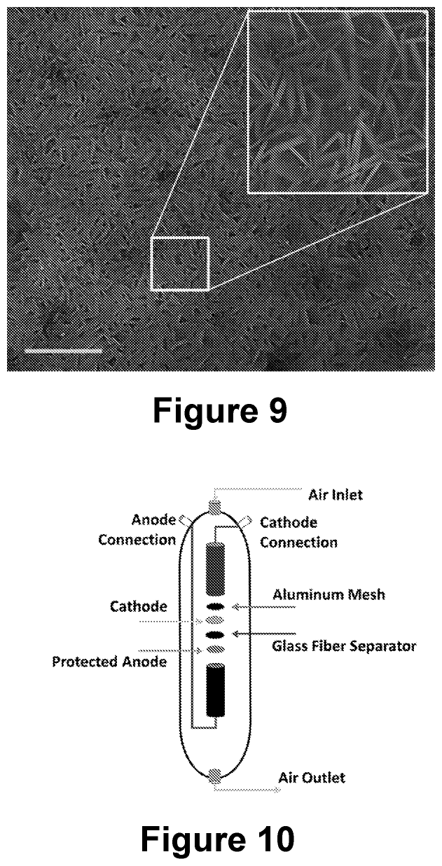

The surface structure and morphology of a protected anode were investigated through scanning electron microscopy (SEM). A protected lithium anode prepared according to Example 1 was characterized. SEM images were acquired at an acceleration voltage of (EHT) 10 kV in lens magnification of 15 kX and an acceleration voltage of (EHT) 10 kV in lens magnification of 25 kX. The SEM image of the surface of the protected anode (See, FIG. 9), shows the formation of rod-shaped products, which are consistent with a Li₂CO₃ species.

1-69. (canceled)

70. A protected anode comprising a protective layer disposed on an anode comprising a metal, wherein the protective layer comprises a carbonate of the metal in an amount of at least 50 atom % of the protective layer.

71. A protected anode according to claim 70, wherein the metal is lithium, magnesium, zinc or aluminum.

72. A protected anode according to claim 70, wherein the metal is lithium.

73. A protected anode according to claim 70, wherein the protective layer has a thickness in the range of 5 nm to 40 microns.

74. A protected anode according to claim 70, wherein the anode consists essentially of the metal.

75. A protected anode according to claim 70, made by a method comprising
providing an electrochemical cell comprising
a first cathode comprising at least one transition metal dichalcogenide,
an anode comprising a metal,
an electrolyte in contact with the transition metal dichalcogenide of the cathode and the metal of the anode, and
carbon dioxide dissolved in the electrolyte; and
performing a discharge-charge cycle comprising
discharging the electrochemical cell, and
applying a voltage across the anode and the first cathode for a time sufficient to charge the electrochemical cell;
wherein the carbon dioxide is present in the electrolyte in a concentration of at least about 25% of the saturated concentration of carbon dioxide in the electrolyte wherein the electrochemical cell is substantially free of water; and
wherein one or more chemical species formed in the discharge-charge cycle and dissolved in the electrolyte are deposited onto the anode to form the protective layer.

76. A protected anode according to claim 75, wherein in the method the electrochemical cell comprises less than 1 wt % water with respect to the electrolyte.

77. A protected anode according to claim 75, wherein in the method the electrochemical cell the electrochemical cell comprises less than 2 wt % H₂ and less than 2 wt % O₂ with respect to the electrolyte.

78. A protected anode according to claim 75, wherein in the method the electrolyte comprises a metallic ion.

79. A protected anode according to claim 75, wherein in the method the material of the transition metal dichalcogenide-containing cathode includes at least 50 wt. % transition metal dichalcogenide.

80. A protected anode according to claim 75, wherein in the method each transition metal dichalcogenide is in nanoflake, nanosheet or nanoribbon form.

81. A protected anode according to claim 75, wherein in the method the electrolyte comprises at least 10% of an ionic liquid.

82. A battery comprising
the protected anode of claim 70;
a second cathode; and
an electrolyte in contact with the anode, and optionally with the metal of the anode.

83. The battery according to claim 82, configured as a metal-air battery.

84. The battery according to claim 82, configured as a metal-ion battery or a metal-sulfur battery.

85. The battery according to claim 82, wherein the second cathode does not comprise a transition metal dichalcogenide.

86. A method for making a protected anode comprising a protective layer disposed on an anode comprising a metal, wherein the protective layer comprises a carbonate of the metal, the method comprising
providing an electrochemical cell comprising
a first cathode comprising at least one transition metal dichalcogenide,
an anode comprising a metal,
an electrolyte in contact with the transition metal dichalcogenide of the cathode and the metal of the anode, and
carbon dioxide dissolved in the electrolyte; and
performing a discharge-charge cycle comprising
discharging the electrochemical cell, and
applying a voltage across the anode and the first cathode for a time sufficient to charge the electrochemical cell;
wherein the carbon dioxide is present in the electrolyte in a concentration of at least about 25% of the saturated concentration of carbon dioxide in the electrolyte wherein the electrochemical cell is substantially free of water; and
wherein one or more chemical species formed in the discharge-charge cycle and dissolved in the electrolyte are deposited onto the anode to form the protective layer.

87. A method according to claim 86, further comprising removing the protected anode from the electrochemical cell after one or more discharge-charge cycles.

88. A method for making a battery, the method comprising:
providing a protected anode made by the method of claim 87; and
configuring a battery comprising
the protected anode,
the second cathode, and
the electrolyte in contact with the anode, and optionally with the metal of the anode.
